(19) United States
(12) Patent Application Publication
(10) Pub. No.: US 2015/0012668 A1
(43) Pub. Date: Jan. 8, 2015

(54) Method of Communicating Between Multiple Digital Living Network Alliance Networks

(71) Applicant: ArcSoft Hangzhou Co., Ltd., Hangzhou City (CN)

(72) Inventor: Zefei Jiang, Hangzhou City (CN)

(21) Appl. No.: 13/935,486

(22) Filed: Jul. 4, 2013

(51) Int. Cl. H04L 12/46

(52) U.S. Cl. CPC H04L 12/4616
USPC 709/249

(57) ABSTRACT

A method of extending a network utilizing the Digital Living Network Alliance (DLNA) protocol includes providing a first DLNA network being a local area network (LAN) conforming to the DLNA protocol and a second DLNA network being a LAN conforming to the DLNA protocol. Communication is established between the first DLNA network and the second DLNA network, the first DLNA network and the second DLNA network communicating with each other over a wide area network (WAN). Multimedia content is then output from a digital media server (DMS) of the first DLNA network to a digital media renderer (DMR) or a digital media player (DMP) of the second DLNA network.

### BACKGROUND OF THE INVENTION

1. Field of the Invention

The invention relates to Digital Living Network Alliance (DLNA) networks, and more particularly, to a method of communicating between multiple DLNA networks so that multimedia content stored in one DLNA network can be played in another DLNA network.

2. Description of the Prior Art

With consumer electronics becoming increasingly popular, there has been a trend to link electronic devices together in order to permit communication or sharing between various devices. However linking two or more devices together is not always a simple task.

Conventionally, if two devices belong to different networks, the devices will have no way to communicate with one another. Thus, multimedia content from a device belonging to a first network will not be able to be shared with another device belonging to a second network. Thus, playing multimedia content from one device on another device has traditionally had the limitation of the two devices needing to belong to the same network. This is a limitation to the conventional method of playing multimedia content that is need of improvement.

### SUMMARY OF THE INVENTION

It is therefore one of the primary objectives of the claimed invention to provide a method of extending a network utilizing the Digital Living Network Alliance protocol.

According to an exemplary embodiment of the claimed invention, a method of extending a network utilizing the Digital Living Network Alliance (DLNA) protocol is disclosed. The method includes providing a first DLNA network being a local area network (LAN) conforming to the DLNA protocol and a second DLNA network being a LAN conforming to the DLNA protocol. Communication is established between the first DLNA network and the second DLNA network, the first DLNA network and the second DLNA network communicating with each other over a wide area network (WAN). Multimedia content is then output from a digital media server (DMS) of the first DLNA network to a digital media renderer (DMR) or a digital media player (DMP) of the second DLNA network.

It is an advantage that the present invention provides a way for two independent DLNA networks to communicate with one another and share multimedia content with one another. Access can be limited to only those having permission to access a DLNA network. For those who have been granted permission to access a DLNA network, multimedia content from the DLNA network can be accessed from anywhere that the user is able to connect to the DLNA network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a multimedia sharing system according to the present invention.

FIG. 2 is a block diagram illustrating the WDLNA protocol stack according to the present invention.

FIG. 3 is a diagram illustrating peer-to-peer connections in the present invention.

FIG. 4 is a diagram of a multimedia content sharing system in which a NAS device having DMS enabled is sharing multimedia content with a mobile phone.

FIG. 5 is a diagram of a multimedia content sharing system in which a NAS device having DMS enabled is sharing multimedia content with an HDTV having DMR enabled through a mobile phone having DMC enabled.

FIG. 6 is a diagram of a multimedia content sharing system in which a mobile phone having DMC enabled is sharing multimedia content with a computer having DMS enabled.

### DETAILED DESCRIPTION

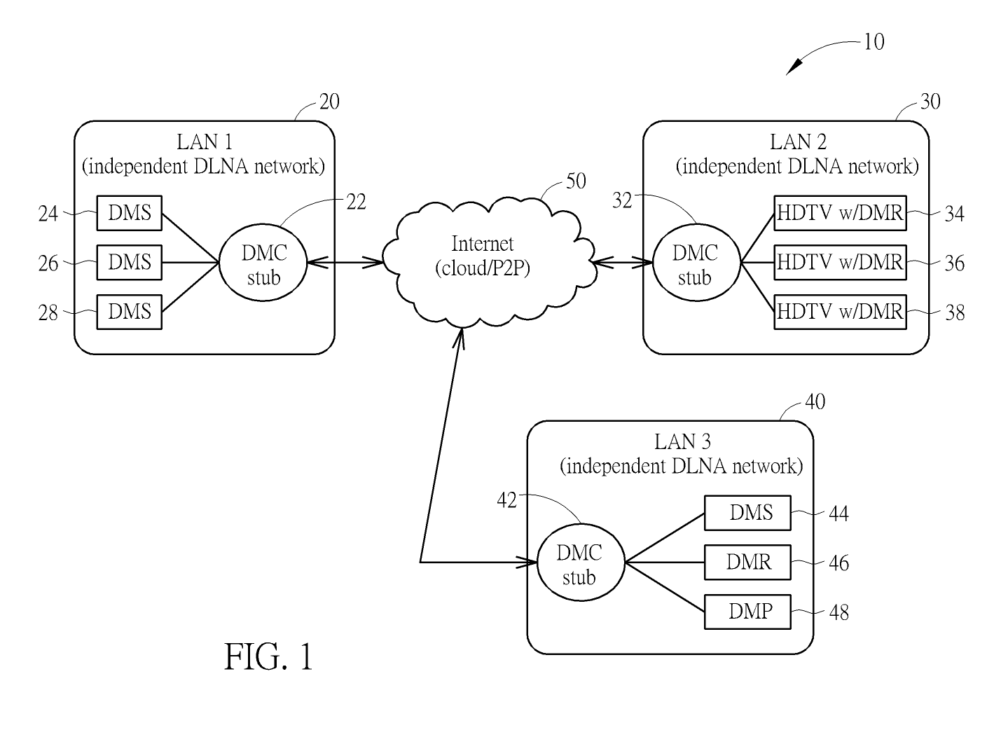

Please refer to FIG. 1. FIG. 1 is a block diagram of a multimedia sharing system 10 according to the present invention. The multimedia sharing system 10 includes a first Digital Living Network Alliance (DLNA) network 20, a second DLNA network 30, and a third DLNA network 40. Each of the first DLNA network 20, the second DLNA network 30, and the third DLNA network 40 is an independent local area network (LAN) that can be connected using wired network cables, using a wireless connection over a wireless local area network (WLAN) connection such as “Wi-Fi” connections adhering to the IEEE 802.11 protocol, or using a combination of wired and wireless connections. The first DLNA network 20 comprises a digital media controller (DMC) stub 22 and three digital media servers (DMSs) 24, 26, 28. The DMSs 24, 26, 28 can be implemented using a computer, a server, a network-attached storage (NAS) device, or any other device that is capable of serving multimedia files to other devices. The DMC stub 22 represents an extension of a standard DMC, and the DMC stub 22 is completely compatible with the DLNA protocol. The DMC stub 22 implements a protocol called WDLNA, in which a DLNA network is implemented over a wide area network (WAN). The WLDNA protocol is based on both peer-to-peer (P2P) communication and DLNA protocols. Not only is the DMC stub 22 compatible with the DLNA protocol for communicating with other DLNA devices, but the DMC stub 22 can also use P2P communication for communicating with other DMC stubs.

The second DLNA network 30 comprises a DMC stub 32 and three digital media renderers (DMRs) 34, 36, 38 that can be implemented using a television (TV), a high-definition television (HDTV), or any other device such as a computer, a tablet computer, or a mobile phone that is capable of playing multimedia content sent to it by the DMC stub 32. In FIG. 1, the DMRs 34, 36, 38 are each HTDVs having DMR functionality.

The third DLNA network 40 comprises a DMC stub 42, a DMS 44, a DMR 46, and a digital media player (DMP) 48. Within the third DLNA network 40, the DMS 44 can serve multimedia content to both the DMR 46 and the DMP 48. The DMP 48 differs from the DMR 46 in that the DMR can only play multimedia content from the DMS 44 as instructed by the DMC stub 42, whereas the DMP 48 can pull content directly from the DMS 44 for playback on the DMP 48. A single device can also function as both a DMP and a DMR.

The first DLNA network 20, the second DLNA network 30, and the third DLNA network 40 communicate with one another through an internet connection 50, which can include any kind of internet connection such as a cloud connection or a P2P connection. For the purposes of the following disclosure, a network can be considered to be a local DLNA network or a remote DLNA network. Taking the DMC stub 22 within the first DLNA network 20 as an example, the DMSs 24, 26, 28 within the same first DLNA network 20 are considered to be local DMS devices, whereas devices within the second DLNA network 30 or the third DLNA network 40 are considered to be in remote DLNA networks. The DMS 44 would therefore be considered as a remote DMS with respect to the DMC stub 22. Devices within each of the first DLNA network 20, the second DLNA network 30, and the third DLNA network 40 communicate with devices within remote DLNA networks via their respective DMC stubs 22, 32, 42. Thus, if the DMR 34 in the second DLNA network 30 is to play multimedia content from the DMS 24 in the first DLNA network 20, the multimedia content passes from the DMS 24 to the DMC stub 22, through the internet connection 50, and through the DMC stub 32 to the DMR 34. Within each of the first DLNA network 20, the second DLNA network 30, and the third DLNA network 40, devices within a local DLNA network communicate with other devices within the local DLNA network using the LAN of the local DLNA network. In contrast, devices within a local DLNA network communicate with other devices within remote DLNA networks via the internet connection 50.

Permission to use a given DLNA network can be granted to other DMC stubs within individual networks, or can be granted to a group DMC stubs corresponding to their own respective networks. For instance, suppose that the first DLNA network 20, the second DLNA network 30, and the third DLNA network 40 all have permission to communicate with one another and to share files with each other. A list of available DMSs within the first DLNA network 20, the second DLNA network 30, and the third DLNA network 40 can then be generated for providing list of content sources. If a user of the DMC stub 42 wishes to play multimedia content on either the DMR 46 or the DMP 48, the user can browse all multimedia content available in any of the available DLNA networks. For example, the user could use the DMC stub 42 to view a list of content available on the DMS 24, the DMS 26, the DMS 28, as well as the DMS 44. Once the user selects multimedia content to view, the user could then use the DMC stub 42 to select either the DMR 46 or the DMP 48 for viewing the selected multimedia content. Thus, multimedia content from both local DLNA networks as well as remote DLNA networks can be played on available playback devices. The present invention therefore provides a method of merging multiple DLNA networks together to form an expanded single DLNA network from the perspective of the end users. Using this technology, a user can access multimedia from anywhere at anytime. With mobile technologies allowing mobile phones or internet connected portable computers to serve as mobile DMC stubs that can also play back multimedia content, the user can even view the multimedia technology wherever the user goes. The user can access favorite files, music, photos, and videos on mobile devices such as a mobile phone, and can take this content wherever the user goes. Secure network and internet connections can be used to ensure the user's privacy and security.

In order for a DLNA network to communicate with remote DLNA networks according to the present invention method, each DLNA network needs to have at least one DMC stub instance installed. The WDLNA protocol implemented on the DMC stubs allows a given DMC stub to browse multimedia content located on all DMSs of remote DLNA networks in addition to DMSs of local DLNA networks. The user can also playback all multimedia content located on all DMSs of remote DLNA networks. A user of a DMC stub can stream multimedia content from remote DLNA networks for playback on local DMRs and DMPs. It will be appreciated that the streaming can be done over a wired connection or a wireless connection. The user of the DMC stub can also download any multimedia content from DMSs of remote DLNA networks as well as upload multimedia content to DMSs of remote DLNA networks.

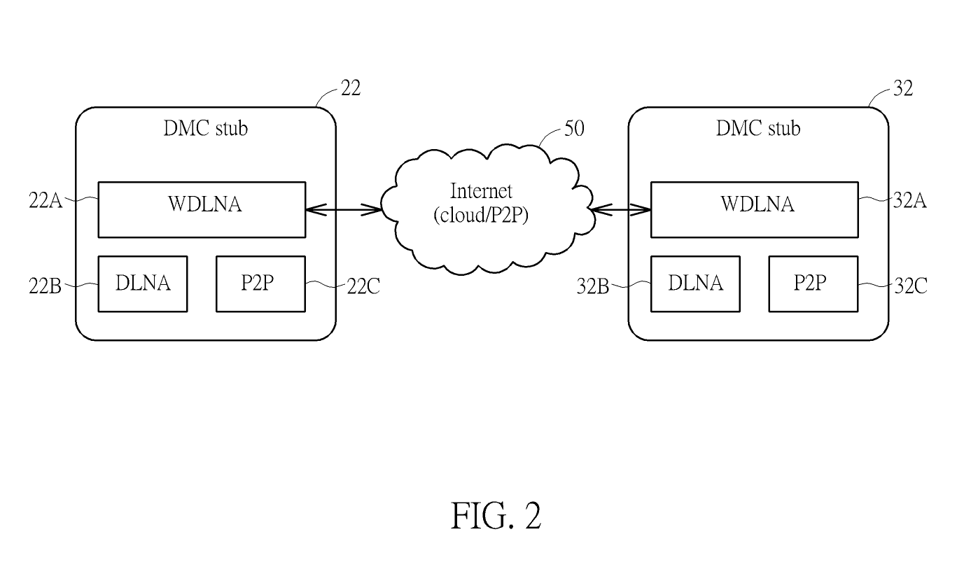

Please refer to FIG. 2. FIG. 2 is a block diagram illustrating the WDLNA protocol stack according to the present invention. As mentioned above, each of the DMC stubs implements a protocol called WDLNA that is compatible with both DLNA and P2P protocols. Thus, the DMC stub 22 has a protocol stack containing WDLNA 22A as a protocol layer above both DLNA 22B and P2P 22C protocol layers. The DMC stub 32 similarly has a protocol stack containing WDLNA 32A as a protocol layer above both DLNA 32B and P2P 32C protocol layers. The DMC stub 22 and the DMC stub 32 communicate with each other over the internet connection 50.

Using the DMC stub 22 as an example, additional features of the WDLNA protocol will be explained below. The WDLNA protocol is a private protocol implemented by the DMC stub 22 that is fully compatible with the DLNA protocol. The DMC stub 22 can connect with remote DLNA networks over a WAN. The WDLNA protocol can send the list of local DMSs to remote DMC stubs, as well as send the online and offline status messages of local DMSs to remote DMC stubs. The WDLNA protocol can also send other DLNA compatible messages from a local DMS and local DMC stub to remote DMC stubs. If there are multiple DMC stubs in a remote DLNA network, the WDLNA protocol will select only one of the DMC stubs in the remote DLNA network to connect with. However, if the remote DMC stub that the local DMC stub is currently connected to is offline, the WDLNA protocol will select a different remote DMC stub to connect with instead, if available. The WDLNA protocol also implements access privilege control, in which only permitted DLNA networks can communicate with each other.

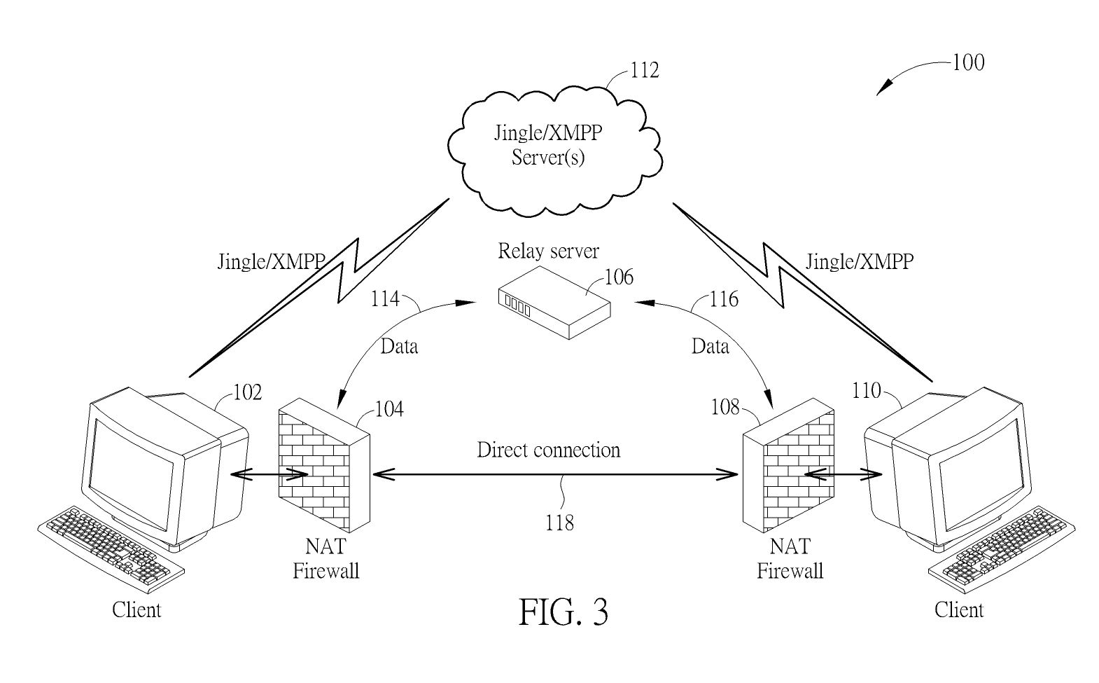

Please refer to FIG. 3. FIG. 3 is a diagram illustrating peer-to-peer connections in the present invention. The WDLNA protocol can use any suitable technology to create a P2P data connection. FIG. 3 illustrates one technology in detail. A P2P connection can be used to transfer data between different DLNA networks. The P2P connection can be created over any kind of WAN connection, including a Wi-Fi network, a LAN, a 3G mobile phone communications network, a 4G mobile phone communications network, or a long-term evolution (LTE) mobile phone communications network.

As shown in FIG. 3, a client 102 in a first network communicates with a client 110 in a second network. The client 102 can go through a network address translation (NAT) firewall 104, and the client 110 can go through a NAT firewall 108 for connecting with each other directly through a direct connection 118. Alternatively, data 114 can be exchanged between the NAT firewall 104 and a relay server 106, and data 116 can be exchanged between the relay server 106 and the NAT firewall 108 for facilitating communication between the client 102 and the client 110. One or more servers 112 conforming to the Extensible Messaging and Presence Protocol (XMPP) protocol or the Jingle extension of the XMPP protocol can also be used for coordinating the P2P interactions between the client 102 and the client 110. Both the client 102 and the client 110 can have an account for logging into the cloud XMPP server 112. Using this account, permission can be granted to other peers having different accounts for sharing access to DLNA networks with others. Furthermore, WDLNA can be integrated within existing XMPP networks since the XMPP protocol is used to create P2P connections.

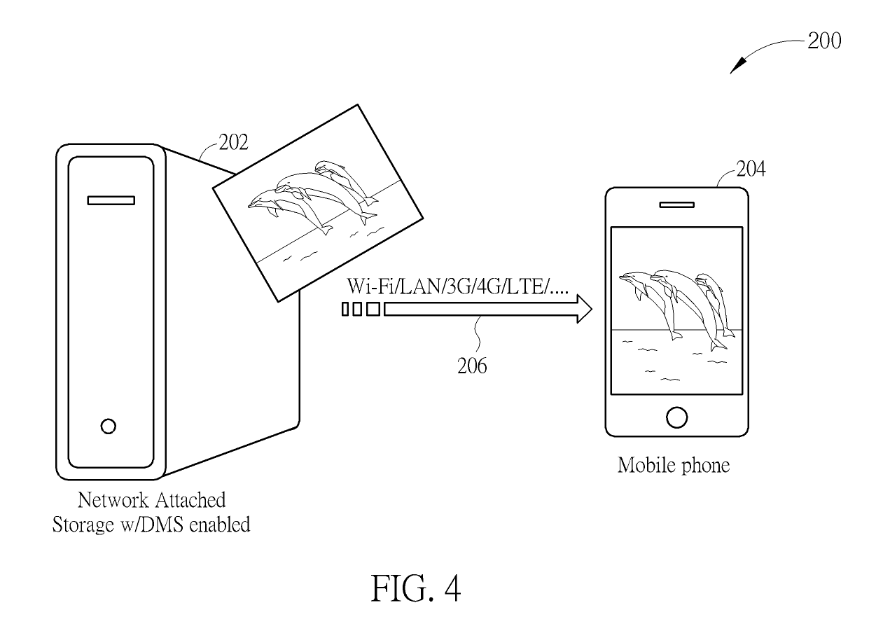

Please refer to FIG. 4. FIG. 4 is a diagram of a multimedia content sharing system 200 in which a NAS device 202 having DMS enabled is sharing multimedia content with a mobile phone 204. The mobile phone 204 may be acting as a DMC stub or a DMP, and selects and receives the multimedia content from the NAS device 202. The NAS device 202 and the mobile phone 204 are in remote DLNA networks with respect to one another, and may communicate via a connection 206 such as a Wi-Fi network, a LAN, a 3G mobile phone communications network, a 4G mobile phone communications network, or an LTE mobile phone communications network. The NAS device 202 and the mobile phone 204 may also be in the same local DLNA network, although in this case the NAS device 202 and the mobile phone 204 will communicate with one another through a Wi-Fi network or a LAN. Multimedia content such as music, photos, or videos can be stored on the NAS device 202. The mobile phone 204 can remotely browse the list of multimedia content stored on the NAS device 202 and can play the multimedia content on the mobile phone 204.

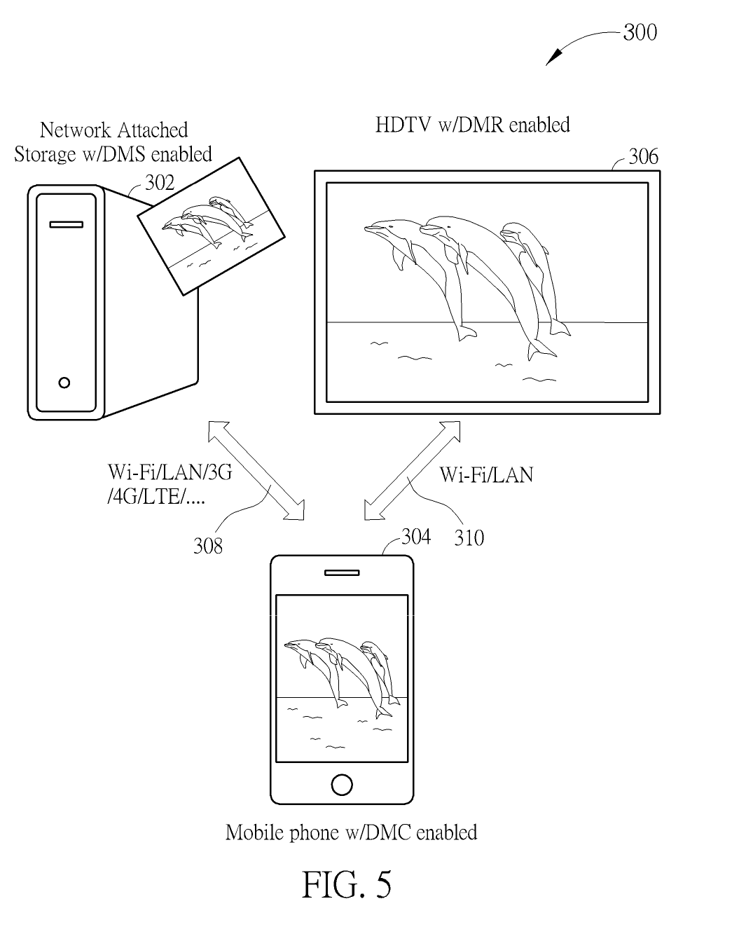

Please refer to FIG. 5. FIG. 5 is a diagram of a multimedia content sharing system 300 in which a NAS device 302 having DMS enabled is sharing multimedia content with an HDTV 306 having DMR enabled through a mobile phone 304 having DMC enabled for acting as a DMC stub. The mobile phone 304 selects and receives the multimedia content from the NAS device 302, and then transfers the received multimedia content to the HDTV 306. The NAS device 302 and the mobile phone 304 are in remote DLNA networks with respect to one another, and may communicate via a connection 308 such as a Wi-Fi network, a LAN, a 3G mobile phone communications network, a 4G mobile phone communications network, or an LTE mobile phone communications network. The mobile phone 304 and the HTDV 306 are in the same local DLNA network, and may communicate with one another through a connection 310 such as a Wi-Fi network or a LAN. Multimedia content such as music, photos, or videos can be stored on the NAS device 302. The mobile phone 304 can remotely browse the list of multimedia content stored on the NAS device 302, and can select multimedia content to be played on the HDTV 306 via NAS device 302 and the mobile phone 304.

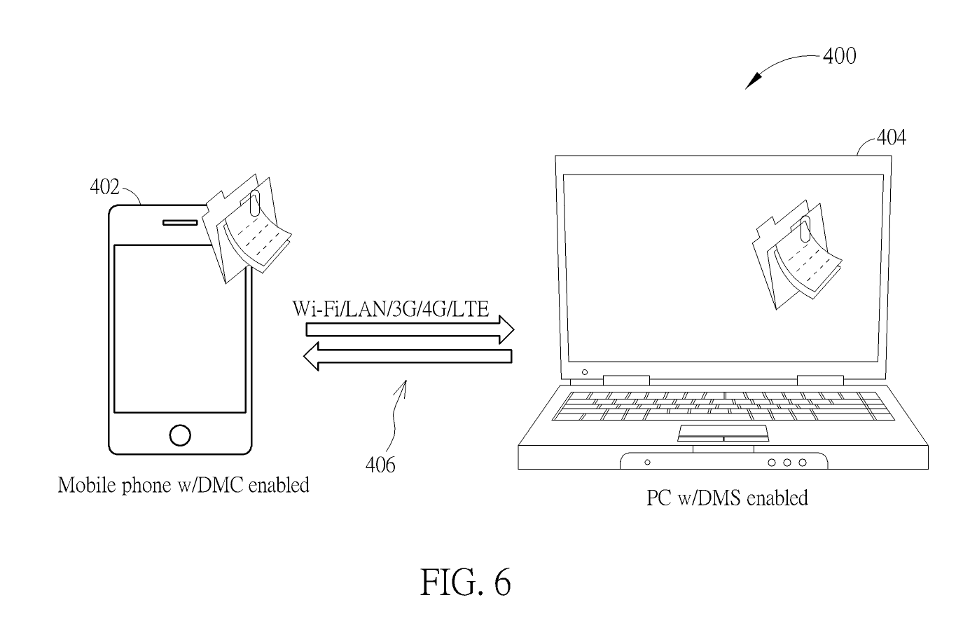

Please refer to FIG. 6. FIG. 6 is a diagram of a multimedia content sharing system 400 in which a mobile phone 402 having DMC enabled for acting as a DMC stub is sharing multimedia content with a computer 404 having DMS enabled. The mobile phone 402 and the computer 404 are in remote DLNA networks with respect to one another, and may communicate via a connection 406 such as a Wi-Fi network, a LAN, a 3G mobile phone communications network, a 4G mobile phone communications network, or an LTE mobile phone communications network. The mobile phone 402 may upload files to the computer 404 through the connection 406 or may play or download multimedia content or files from the computer 404 through the connection 406. The computer 404 may also be other types of remote DMS devices, such as a NAS device, a server, and so on.

In summary, the present invention provides a way for multiple independent DLNA networks to communicate with one another and share multimedia content with one another. Access to a given DLNA network can be granted only to other authorized DLNA networks. For those who have been granted permission to access a DLNA network, multimedia content from the DLNA network can be accessed from anywhere that the user is able to connect to the DLNA network.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of extending a network utilizing the Digital Living Network Alliance (DLNA) protocol, the method comprising:
providing a first DLNA network being a local area network (LAN) conforming to the DLNA protocol and a second DLNA network being a LAN conforming to the DLNA protocol;
establishing communication between the first DLNA network and the second DLNA network, the first DLNA network and the second DLNA network communicating with each other over a wide area network (WAN); and
outputting multimedia content from a digital media server (DMS) of the first DLNA network to a digital media renderer (DMR) or a digital media player (DMP) of the second DLNA network.

2. The method of claim 1, wherein the first DLNA network comprises a first digital media controller (DMC) stub and the second DLNA network comprises a second DMC stub, and the method further comprises:
the first DLNA network granting the second DMC stub access to the first DLNA network for sharing the multimedia content from the DMS of the first DLNA network to the DMR or the DMP of the second DLNA network via the first DMC stub and the second DMC stub.

3. The method of claim 2, further comprising:
obtaining, with the second DMC stub, a list of available DMSs from the first DLNA network via the first DMC stub;
obtaining, with the second DMC stub, a list of available DMSs from the second DLNA network; and
integrating, with the second DMC stub, the list of available DMSs from the first DLNA network with the list of available DMSs from the second DLNA network for creating a combined list of available DMSs.

4. The method of claim 3, further comprising:
listing available multimedia content from the combined list of available DMSs on the second DMC stub.

5. The method of claim 2, further comprising:
obtaining, with the second DMC stub, a list of available DMSs from the first DLNA network via the first DMC stub; and
listing available multimedia content from the list of available DMSs from the first DLNA network on the second DMC stub.

6. The method of claim 5, further comprising:
receiving, with the second DMC stub, selection of multimedia content from the list of available multimedia content by a user of the second DMC stub;
receiving, with the second DMC stub, selection of the DMR of the second DLNA network by the user of the second DMC stub; and
playing the selected multimedia content on the selected DMR.

7. The method of claim 5, further comprising:
receiving, with the second DMC stub, selection of multimedia content from the list of available multimedia content by a user of the second DMC stub;
receiving, with the second DMC stub, selection of the DMP of the second DLNA network by the user of the second DMC stub; and
playing the selected multimedia content on the selected DMP.

8. The method of claim 2, further comprising:
uploading, with the second DMC stub, content from the second DMC stub to the DMS of the first DLNA network.

9. The method of claim 2, further comprising:
downloading, with the second DMC stub, content from the DMS of the first DLNA network to the second DMC stub.

10. The method of claim 2, wherein the first DMC stub and the second DMC stub are compatible with the DLNA protocol.

11. The method of claim 2, wherein the first DMC stub and the second DMC stub utilize a peer-to-peer communication protocol for transferring data between one another.

12. The method of claim 1, wherein the WAN utilizes a Wi-Fi network, a LAN, a 3G mobile phone communications network, a 4G mobile phone communications network, or a long-term evolution (LTE) mobile phone communications network for connecting the first DLNA network and the second DLNA network.
